(19) United States
(12) Patent Application Publication
(10) Pub. No.: US 2005/0102838 A1
(43) Pub. Date: May 19, 2005

(54) Clam Shell and Blister Package Opening Device and Method for Using Same

(76) Inventor: David Leason, Chappaqua, NY (US)

Correspondence Address: DAVID LEASON, 28 GAREY DRIVE, CHAPPAQUA, NY, 10514, US

(21) Appl. No.: 10/906,443

(22) Filed: Feb. 20, 2005

(51) Int. Cl. B26B 1/00

(52) U.S. Cl. 30/134

(57) ABSTRACT

Opening a blister or clam shell package with a continuous linear cut includes positioning the package between jaws, at least one of which includes a cutting surface, moving the jaws to a compressed position in which the cutting surface penetrates the package, and sliding the jaws relative to the package while maintaining the jaws in the compressed position. Several handheld devices to implement the method are described, including variations in which the handheld device has fixed jaws and in which the device is an appliance. Devices include at least one bearing surface which reduces the risk of cutting users and things other than the package to be opened.

### FIELD OF THE INVENTION

The present invention relates to safe methods and devices for opening sealed packages, and in particular clam shell or blister packages.

### BACKGROUND OF THE INVENTION

Products are routinely packaged in sealed plastic containers so as to reduce cost or theft, increase product visibility, provide integral hang tabs, permit interaction with a prospective customer, and for a combination of these and other reasons. Sealed plastic containers can be difficult to open once purchased, especially by children or older purchasers. In the case of clam shell packaging, often a scissor or knife is required to open the plastic film, and safety issues abound, particularly because the formed package presents solid surfaces of varying orientation that are difficult to cut with a household scissor. In addition, the sharp or jagged edge of a partially opened package can present hazards to persons grappling with opening such packages.

Among specialty cutters for opening certain packages is one designed for severing foil from the top of a wine bottle. One such cutter construction includes a compressible housing that is constructed to be placed over the top of the bottle, squeezed and then twisted (rotated) to slice the foil. The blades are typically recessed within the compressible housing to minimize risk of injury, yet can cut while in that recessed position because the housing is specially configured to cooperate with the top of a wine bottle when rotated. See, for example, U.S. Pat. Nos. D454,288, D458,820 and D474,383.

Another specialty cutter that addresses the removal of material from a generally cylindrical object is a cigar cutter. Cigar cutters operate to prepare a cigar for use rather than to open a package containing the cigar. In any event, an exemplary cigar cutter design is illustrated in U.S. Pat. No. D455,521, which is essentially a miniature guillotine: a blade travels across an aperture in the housing to sever a stationary object disposed in that aperture.

Still another specialty cutter is a coaxial wire stripper which is configured to remove an outer jacket and dielectric layer to expose a centrally disposed inner conductor. An exemplary coaxial cable stripper is available from RadioShack®, catalog item number 278-0248 which can cut coaxial cables of various standard sizes. The coaxial cable stripper housing has jaws that separate to permit the end of a cable to be stripped to be seated therein. The housing is rotated about the cable while a blade within the jaws cuts the outer jacket and dielectric. The wire stripper is effective in making radial cuts through cable wires, but is not suited for linear cuts nor is there a reason in the wire cutting art to make a linear cut.

The present invention provides an opener having a configuration adapted to solve one or more problems presented in opening clam shell and blister packages, which differ from those of specialty cutters such as noted above.

### SUMMARY OF THE INVENTION

In accordance with one aspect of the invention, a method is provided for opening a blister or clam shell package. In the inventive method, the package is positioned between at least two moveable jaws (e.g., between two jaws). At least one of the moveable jaws includes a blade having a cutting surface mounted so as to be moveable at least into proximity with the other of the moveable jaws. Then, the jaws are moved to a compressed position in which the cutting surface penetrates the package positioned between the jaws. The jaws are then slid relative to the package while maintaining the jaws in said compressed position. As a result, a continuous linear cut through the package can be had from as little as a simple compress and slide motion.

In further aspects of the inventive method, step of moving the jaws can comprise urging the jaws to the compressed position against a restoring force of a bias, or, instead, permitting a restoring force to return the jaws to the compressed position.

In still a further aspect of the inventive method, the additional step of disposing the cutting surface exterior of one of the jaws can be performed, for example, when the blade is moveably mounted within at least one of the jaws.

In accordance with a different aspect of the present invention, a handheld device for cutting a package includes a first jaw, a second jaw, a coupling connecting the first and second jaws and permitting relative movement of the first and second jaws to one another in response to a manual force, a blade mounted to the first jaw and having a cutting surface disposed exteriorly of the first jaw, and a bias operatively connected to the first and second jaws to counter the manual force. The jaws move between i) a receiving position in which the first and second jaws are spaced at a distance sufficient to receive the package in a channel defined therebetween and ii) a cutting position in which the distance between the first and second jaws is decreased and in which the cutting surface penetrates any package received in the channel.

Yet another handheld device in accordance with still a further aspect of the invention supports a moveable blade for cutting a package. Such a device comprises a first jaw, a second jaw, a coupling connecting the first and second jaws and permitting relative movement of the jaws, a bias, a blade having a cutting surface, and structure that moves the cutting surface of the blade between retracted and extended positions. Preferably, the position of the cutting surface can be controlled independent of the position of the jaws.

Handheld devices in accordance with the invention can include a bearing surface which is associated with the second jaw, wherein the blade is disposed directly above or contacts the bearing surface when in the cutting position. Optionally, the bearing surface includes structure to reduce friction between the handheld device and a package being opened by the handheld device.

Handheld devices in accordance with the invention also can include features that move the blade in response to any pressure applied to the jaws.

Still another handheld device in accordance with a different aspect of the invention cuts open a package in a construction in which jaws are stationary, yet a blade is mounted such that the blade can move to produce a linear cut in the package. Such a device has a first jaw and a second jaw which are spaced from one another at a fixed distance which is sufficient to receive the package in a channel defined at least partially between the jaws. A blade having a cutting surface is moveably mounted relative to the first jaw and has a retracted state in which the cutting surface is disposed interiorly of the first jaw and an extended state in which the cutting surface is disposed exteriorly of the first jaw, yet within the channel so as to penetrate any package that has been received in the channel. A lever connects to the blade and is operative to move the cutting surface between the retracted and extended states.

These and other features, aspects and advantages can be appreciated from the following written description and the accompanying drawing figures.

### BRIEF DESCRIPTION OF THE DRAWINGS

FIG. 1 is a side view of a device in accordance with a first embodiment of the invention, shown in an open position;

FIG. 2 is a side view of the device of FIG. 1, shown in a closed position with a portion partially cut away to illustrate details of an arrangement for a bearing surface and for a jaw-bias;

FIG. 3 is a cross-sectional view taken along line 3-3 of FIG. 1;

FIGS. 4A and 4B are sectional views of an upper jaw constructed in accordance with a second embodiment showing the blade in retracted and extended positions, respectively;

FIGS. 5A and 5B are respective sectional views of the device of FIGS. 4A and 4B taken along line 5-5 of FIG. 4B showing a mechanism for moving the blade between the retracted and extend positions;

FIG. 6 is a side view of a device in accordance with a third embodiment of the invention, shown in an open position;

FIG. 6A is a detailed perspective view of a particular arrangement of a bearing surface that may be used with one or more of embodiments of the invention;

FIG. 7 is a perspective view of a conventional clam shell container that can be opened using devices constructed in accordance with the invention, and FIG. 7A shows the same container in side view;

FIG. 8 is a perspective view of a standard blister package, and FIG. 8A shows the same package in side view;

FIG. 9 is a perspective view of a double-card blister package, and FIG. 9A shows the same package in a side-sectional view;

FIG. 10 is a perspective view of a monomaterial blister package, and FIG. 10A shows the same package in a side-sectional view;

FIG. 11 is a perspective view of a monomaterial double-blister package, and FIG. 11A shows the same package in side view;

FIG. 12 is a perspective view of a knob blister/press-stud package, and FIG. 12A illustrates the same package in a side view; and

FIG. 13 illustrates a blister package configured to individually seal medications in the form of pills, tablets, capsules, and other non-liquid oral dosage forms, and FIG. 13A is a detailed, sectional-view of one sealed blister.

### DESCRIPTION OF CERTAIN EMBODIMENTS

By way of overview and introduction, the present invention concerns devices that can cut through plastic films, cardboard and other materials using the combined action of a clamp and a cutting edge that permit a simple sliding movement to produce a linear cut through such materials. Devices in accordance with the invention are suitable for cutting clam shell packages and blister packages to provide consumers with access to their contents in a reliable and safe manner. Packages are inserted between at least two jaws into a channel (or mouth) defined the device, and are cut while seated in that channel. Larger mouths (e.g., on the order of 0.25″ and larger) are better suited for opening clam shell packaging while smaller mouths (e.g., less than 0.25″) are well suited for opening certain blister packages such as those that contain medicines. Preferably, the device is configured for hand-held operation.

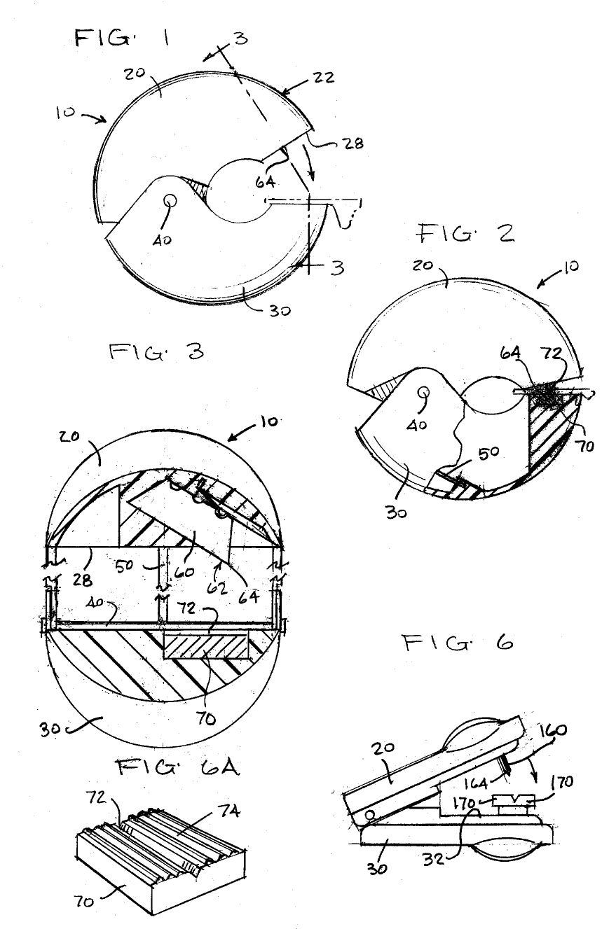

In FIG. 1, a first embodiment of a device 10 includes an upper jaw 20 and a lower jaw 30 that are coupled together. An axle 40 with rivets at either end can be used to secure the jaws together and permit pivotal movement of the jaws in response to a manual force. Other arrangements can be utilized, such as a living hinge, when movement of the jaws is part of the design of a particular embodiment. Thus, for example, a living hinge can be formed using the same material that constitutes the upper and lower jaws, such as by a molding or extrusion process. A living hinge can also be formed by a co-extrusion method in which a second material can surround the jaws and provide an exterior grasping surface for the device 10.

In the illustrated embodiment, the jaws are sized and shaped so as to be pivoted relative to one another about the axle 40. Preferably, as illustrated, the upper jaw has an ergonomically shaped exterior surface 22 (that can be squeezed between a thumb and one or more fingers of a user's hand). The jaw 30 has an interior cavity configured to receive at least a portion of the upper jaw 20 when the device is pivoted toward a closed or compressed position (FIG. 2). The terms “upper” and “lower” are used for ease of reference to the drawings and comprise, more generally, first and second jaws that are moveable relative to one another. The jaws are preferably formed using tooling of conventional construction that has been fabricated to make the device 10.

In FIG. 3, a sectional view of the device 10 illustrates further details of a preferred embodiment. A hinge hole is provided in the upper and lower jaws, respectively, and the holes are in register with one another when the device is assembled in order to receive the axle 40 therethrough. Also in the preferred embodiment, a compressed spring 50 biases the jaws 20, 30 into the open configuration of FIG. 1. As illustrated, the spring 50 is a leaf spring having opposing ends that are disposed within seats (such as seat 36 illustrated in FIG. 2) that are formed in the upper and lower jaws, respectively. The seats prevent the leaf spring from returning to its uncompressed resting state. Different biasing mechanisms can be used to place the jaws in an open-biased configuration. For example, a coil spring with elongate opposing arms (not shown) could be positioned about the axle 40, with the coil seated in a tensioned state and each of the opposing arms bearing against an interior surface of a respective upper and lower jaw. Such leaf and coil springs are available from numerous spring works companies.

In the open state (FIG. 1), the device 10 is in a receiving position, ready to receive a package (shown in phantom lines) to be cut open. In the receiving position, the first and second jaws are spaced at a distance sufficient to receive the package in a channel at least partially defined between the jaws. In the closed state (FIG. 2), the device 10 is in a cutting position in which the distance between the first and second jaws has been decreased, such as due to a manual force overcoming (countering) the bias in order to bring the jaws together. In the cutting position, a cutting surface of a blade (described next) penetrates any package that has been received in the channel.

It should be understood that while an open-biased configuration is useful for purposes of illustration, embodiments can be constructed in which the spring 50 operates to normally bias the device 10 to a closed position. In such alternative embodiments, the bias presents a restoring force which is countered by a manual force applied to exterior surfaces of the device, generally in the same way that a binder clip operates (see U.S. Pat. No. 5,896,624 for a binder clip having actuating arms 8, 9), in order to open the jaws. In embodiments in which the device is normally biased to a closed, cutting position, the device also can be opened by way of a force applied to a cam. For example, a cam surface 34 can be provided adjacent a bearing surface 70 on the lower jaw which permits the jaws to move to another position in response to pressure applied by an edge of the package when urged against the cam surface. The cam surface can comprise a slope or radiused edge 34 that guides a package between the jaws into position for cutting. If a cam is provided, the jaws move a distance just sufficient to receive the package into the channel to then be cut open; the jaws need not open beyond that such distance, such as to be able to freely receive a package as in embodiments in which the jaws are biased to an open position.

With further reference to FIG. 3, in accordance with a salient aspect of the invention, the device 10 includes a cutting element that is oriented to permit the package to be cut when seated in the channel between stationary jaws 20, 30. More particularly, device 10 includes a blade 60 that is preferably oriented generally transverse to the opening between the jaws, and is oriented so as to produce a linear cut through the package when the package is moved in a direction which engages a cutting surface 62 of the blade. The cutting surface 62 projects from a lower margin 28 of the upper jaw 20 so as to engage a package and produce a linear cut through the package with relative movement of the package and the device 10, while the first and second jaws remain in the cutting position.

The bearing surface 70 can be disposed so as to be just below or so as to physically engage the cutting surface 62 when the device is pivoted to the closed position shown in FIG. 2. The bearing surface 62 can be a region of the lower jaw 30, or can be a separate element attached to the lower jaw. The purpose of the bearing surface is to seat against a side of the package which faces the lower jaw, while the blade 60 engages and perforates the opposite side of the packaging, that is, the side facing the upper jaw. The cutting surface contacts or moves directly above the bearing surface to engage the package. The bearing surface can extend beyond the periphery of the upper jaw to extend one edge of the channel.

The blade 60 is illustrated as a double-ended razor blade, though that is not required. The blade can take on a variety of forms including single-ended razor blades, rotary cutters (optionally with spikes to assist in initial penetration of the package), or sharpened metals or ceramics other than razor blades. Suitable blades can be obtained from a variety of suppliers. One supplier of blades of prescribed and custom sizes is Specialty Blades, Inc. of Staunton, Va. What is important to the invention is that the cutting element be able to pierce the plastic film or card stock of a clam shell or blister package and sever the material as the package is moved against the cutting element. As shown in FIG. 3, the blade 60 is preferably oriented so as to present both a piercing tip 64 and a sharp cutting surface 62. The remainder of the blade 60 (that is, the portions other than the piercing tip and cutting surface) are seated in the upper jaw 20 so that there is substantially no movement of the blade relative to the jaw 20. The remainder of the blade serves no cutting function and need not be sharp or extend beyond a length suitable for securing to the upper jaw. If the blade is a razor, there are conventionally rounded slots on an edge opposite the sharpened edge 62 that can be used to securely seat the blade, for example, using complementary formed cylindrical elements 29 or a clip to brace the blade, either of which can be provided in the upper jaw.

Optionally, the cutting surface can be shielded when the device 10 is not in operation. A shield can comprise a blunt surface that is movable past an exposed edge of the cutting surface, immediately alongside the cutting surface. Shields of this construction are known in the art of rotary cutters. See, e.g., Olfa RTY-3/G 60 mm Rotary Cutter which has a slidable blade cover.

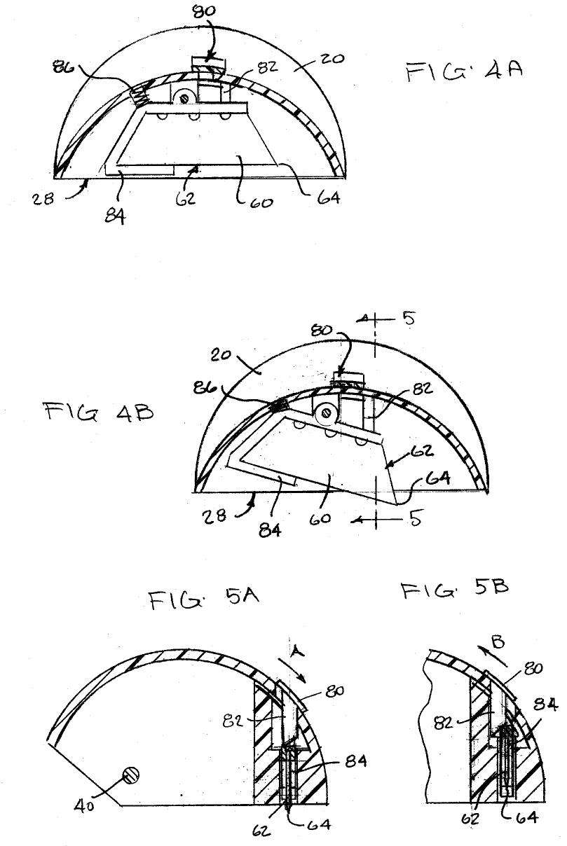

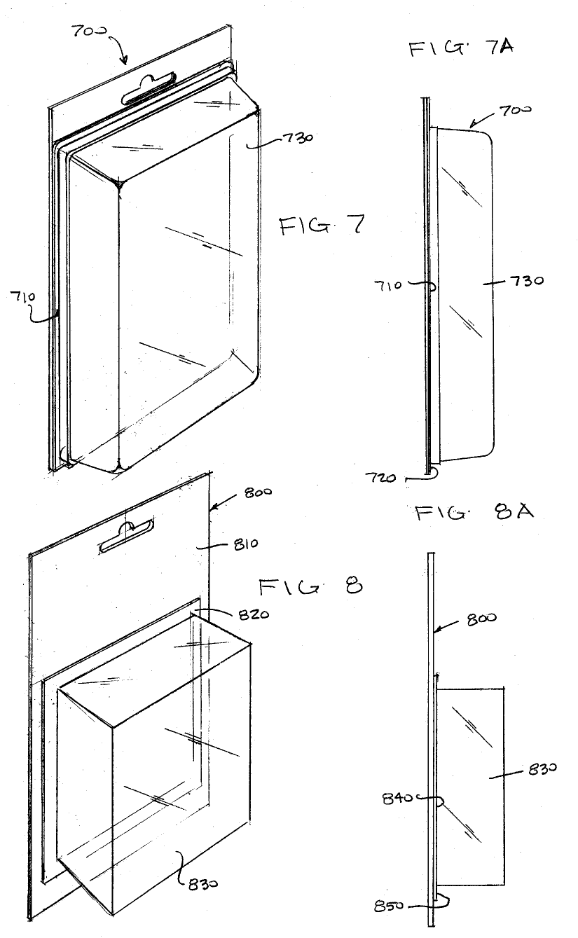

Turning next to FIG. 4A, a second embodiment is illustrated in which like elements have corresponding reference numerals. The second embodiment is similar to the first, except that the upper jaw 20 now has the blade 60 moveable to a retracted position relative to the upper jaw. The blade is preferably biased by a leaf or coil spring 86 into a first position or state (shown in solid line) in which the piercing tip 64 and cutting edge 62 are retracted within the interior of the upper jaw 20. Thus, in this first state, the blade 60 is retracted or its edge is shielded by a closely spaced safety shield to minimize the risk of injury to persons or things in case an object not intended to be cut is placed within the jaws 20, 30. The blade has a second position or state (FIG. 4B) in which the piercing tip 64 and cutting edge 62 project from the upper jaw 20 below the margin 28 into the cavity of the jaws. Thus, in this extended state, the blade 60 is exposed and ready to cut a package placed within the jaws 20, 30. A lever 80 is accessible exteriorly of the upper jaw 20 and is connected to a cam element 82 (see FIGS. 5A and 5B). A blade support 84. The blade support at least partially seats and retains the blade 60 so that movement of the lever causes a corresponding movement of the blade support 84 in response to urging by the cam element 82, and hence a corresponding movement of the blade 60. The lever is moveable along a track in the direction of arrow A to advance the blade 60 from the retracted state to the extended state when manually urged by a user. Movement of the lever, and hence the blade, can be independent of any movement or non-movement of the jaws 20, 30. The bias 86 is tensioned as the lever is moved in the direction of arrow A. The bias 84 draws the blade 60 back to the first position (the direction of arrow B) when the lever 80 is no longer being urged by a user. The bias can be anchored to the upper jaw at one and to the blade support at another and put into tension between those anchor points as the lever is moved in the direction of arrow A. Optionally, the blade support 84 includes a stub to seat the bias 86.

Alternatively, the blade 60 can move in response to the presence of a package within the jaws 20, 30. The bearing surface 70 can float above the lower jaw 30 under the influence of a spring, and serve as a trigger to advance the cutting surface to the extended state in response to increasing pressure bearing down upon the bearing surface. This arrangement further has a coupling between the bearing surface and the blade support 84 which draws the cutting surface downward toward and past the lower margin 28 in response to the bearing surface being pressed further downward (due to the pressure of the jaws 20, 30 pressing upon an interposed package as the jaws compress together). The coupling can be a solid wire anchored to the blade support and bearing surface.

If the blade is moveably mounted, then the jaws need not be movable. In an alternative arrangement to that shown in FIG. 1, the gap between the jaws 20, 30 can be sized to define a channel suitable for accommodating packages of various sizes, for example, the distance between the bearing surface 70 on the lower jaw and the margin 28 of the upper jaw can be 0.50 inch. The blade 60 can then be mounted for movement so as to project substantially into that prescribed channel to cut through any packaging placed therein. The lever 80, the blade housing 84 and the bias 86 can be as described in connection with FIGS. 4A and 4B, but in this arrangement the track that permits travel of the lever in the direction of arrows A and B is longer in order to permit greater movement of the blade 60 so as to traverse the gap and move close to the bearing surface 70. The upper and lower jaws can be separate parts, as in the embodiment of FIG. 1, which are secured together after assembly of the moveable components and the bias. The axle 40 could be omitted as there would be no requirement for a hinge, other than perhaps to permit changing the blade 60. In all other respects, this alternative arrangement is the same as that illustrated in FIGS. 4A and 4B.

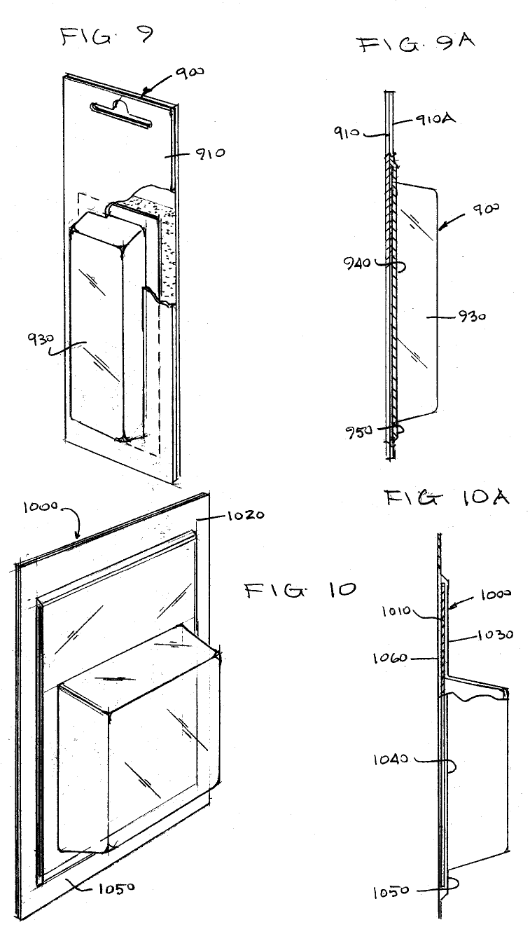

FIG. 6 illustrates a third embodiment of the invention in which like elements have corresponding reference numerals. The third embodiment is similar to the first embodiment, having pivoting upper and lower jaws. The embodiment of FIG. 6 is provided with a cutting element 160 protruding from one of the jaws toward the other of the jaws. The cutting element is arranged to cut material positioned in the jaws along a line that is generally transverse to the direction of insertion of the material. The cutting element preferably has a piercing tip 164 which is tapered so as to penetrate the plastic film or other material of the packaging to be opened when the jaws 20, 30 are pivoted toward a closed position. On the other jaw, one or more bearing surfaces 170 are provided which engage a lower surface of a package inserted between the jaws 20, 30. It is preferable that the bearing surface is raised above the margin 32 and be positioned clear of the path traced by the cutting element 160 as the jaws move to the closed position.

In each of the foregoing embodiments, the bearing surface can include a groove 72 to receive the cutting edge or can include other features to accommodate packaging inserted into the jaws. For example, the bearing surface can be semi-rigid so as to flex in response to compression of the jaws with a package seated therebetween. Alternatively or in addition, the bearing surface 70 and lower margin 28 can be constructed so as to minimize friction between the package and the device 10 as the device 10 is slid along a package edge to cut through the plastic film or card stock. Friction between a package's exterior and the engaging surfaces of the jaws can be reduced in a number of ways. For example, friction is reduced by minimizing the points of contact between the device and the package's exterior. For example, the points of contact can be reduced by providing ridges 74 (FIG. 6A) that are oriented in the direction of travel of the device 10 relative to the package or by including protuberances in the engagement region of the jaws (that is, the bearing surface 70, 170 and the lower margin 28 in the vicinity of the cutting surface 162). Friction also can be reduced by providing the engagement region with contact surfaces that are smooth or that optionally include a coating (e.g., a hydrophilic coating).

It should be understood that features of one embodiment can be included in any of the others, without departing from the teachings of this specification. It should be understood as well that while the foregoing describes pivotal movement of the jaws, that is not critical to practicing the invention. What is important to the invention is that the jaws permit a package to be received therebetween and have a blade that can come into contact with the so-received package to produce a linear cut through the package along the direction of device movement. It is contemplated that this can be achieved without clamping against the exterior of the package, but that is not a preferred mode of practicing the invention.

Free standing appliances can be constructed to include the operative components described in connection with the preceding embodiments. Such appliances can be configured to clamp the packaging automatically upon insertion of the package into a channel instead of by manual movement of the jaws or the blade into the channel. A motor-assist can be provided to move either the jaws to a closed position, the blade into the extended, cutting state, or move both the jaws and the blade, in response to the insertion of a package into the channel. A detector can be positioned to sense the presence of the package in the channel. Thus, the motor can be actuated in response to changes in signals at the detector to move elements in the appliance, such as to close the jaws around the edge of the package to be cut, move the blade from a retracted position to an extended position, or both. The package can then be slid along a guide rail to produce a linear cut through the package along the line of motion defined by the guide rail.

A variety of packages can be opened using devices constructed in accordance with the invention. By way of example, several containers that can be opened with devices in accordance with the invention are discussed in connection with the devices illustrated in FIGS. 1-6, although it should be understood that the alternative arrangements described herein also can be used with these containers using insubstantial variations from what is described below.

FIG. 7 shows a conventional clam shell container of prescribed dimensions. The container has a perimeter that is sealed such as by a heat sealing machine along the perimeter or at spaced locations there along. One or more edges 710, 720 can be inserted into the jaws 20, 30 and the device can be pivoted or otherwise moved to the closed position about the inserted container. If the blade is retracted, it can now safely be moved to the second, extended position. The extended blade penetrates the material at a location that is preferably within the closed jaws, so that the bearing surface opposes or is proximate the cutting edge to protect fingers and furniture as the package is opened. The device can then be slid without any further action and produce a linear cut along the edge 710, 720 to thereby separate the cut edge from the remainder of the container 700. Such cutting differs from the use of scissors in that the device can be reliably and safely positioned about the edge and produce a clean, linear cut. In contrast, repeated scissor-like movements of the user's hand tend to produce a jagged cut edge and can be difficult to cut, especially if the container has an upstanding wall 730 in the vicinity of the edges 710, 720.

As another example, a standard blister package as illustrated in FIG. 8 can be opened using devices constructed in accordance with the invention. The package 800 has a perimeter of card stock 810, part of which includes a sealing border 820 about a centrally disposed blister 830. One or more edges 840, 850 can be inserted into the jaws 20, 30 and the device then pivoted or otherwise moved to the closed position about the inserted package. If the blade is retracted, it can now be safely moved to the second, extended position. The device can then be slid without any further action and produce a clean and linear cut along the edge 840, 850, as previously described.

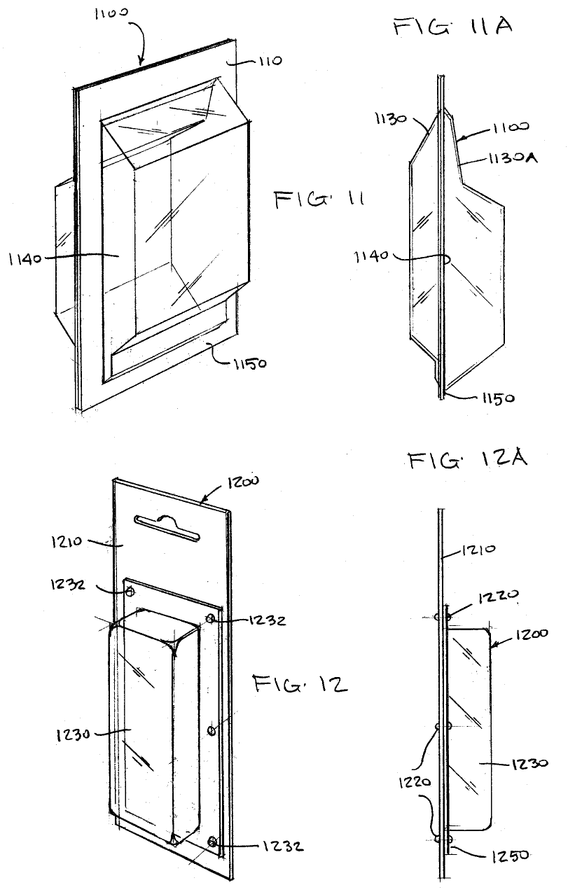

Other blister packages can be opened in the same way. For example, the double-card blister package 900 illustrated in FIG. 9 is substantially the same construction as the blister package of FIG. 8, except there is an additional card stock 910A which rests upon an edge of the blister 930 and conceals an underlying sealing border 920. The blister 930 need not be sealed to the cards 910, 910A in this package construction. One or more edges 940, 950 can be inserted into the jaws 20, 30 and the device then pivoted or otherwise moved to the closed position about the inserted package. If the blade is retracted, it can now be safely moved to the second, extended position. The device can then be slid without any further action and produce a clean and linear cut along the edge 940, 950, as previously described.

FIG. 10 illustrates a monomaterial blister package 1000, having a perimeter sealing area. In the package of FIG. 10, the leaflet card 1010 floats between a rear cover film 1060 and a plastic blister 1030. The sealing area 1020 surrounds the leaflet card, yet edges 1040,1050 are accessible and can be inserted into the jaws 20, 30 of the device in order to open the package 1000 with a clean and linear cut as previously described.

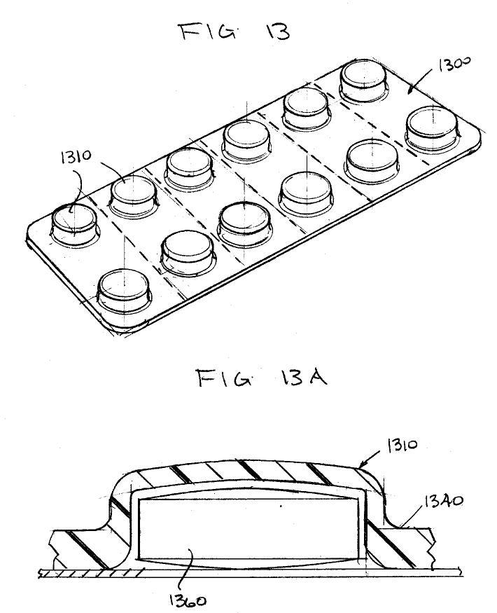

FIG. 11 illustrates a double-blister package 1100 which is defined by back-to-back blisters 1130,1130A. A sealing area 1120 extends along the outer periphery of the blisters and joins them together. Edges 11 40,11 50 are accessible and can be inserted into the jaws 20, 30 of the device in order to open the package 1100 with a clean and linear cut as previously described.

FIG. 12 illustrates a knob blister/press-stud package 1200 which comprises a cover card 1210 having perforations, a blister 1230 having perforations 1232 which align with the perforations of the cover card when the blister is suitably positioned on the cover card, and a set of press-studs 1220 which are received into the respective perforations. The press-studs are of conventional design and include a knob at one end and a locking head on the other for permanent engagement of the card and blister. Edges 1240, 1250 are accessible and can be inserted into the jaws 20, 30 of the device in order to open the package 1200 with a clean and linear cut. Preferably, the interior cavity of the device is shaped to accommodate press studs or other protuberances so that the blade 60 can be positioned inwardly of the press-studs when positioned along one of the edges of the package 1200.

FIG. 13 illustrates a blister package 1300 configured to individually seal medicines 1360 in the form of pills, tablets, capsules, and other non-liquid oral dosage forms. Individual blisters 1310, which may include one or plural sealed medicines 1360, are separable from the package in a conventional manner, but still have to be opened. The individual blisters (see FIG. 13A) can be opened as previously described, and can be opened with a device having a smaller mouth than necessary to open the previously described packages. The individual blister 1310 presents at least one edge 1340 that can be received within the jaws in order to open the blister 1310 with a clean and linear cut, as previously described, and safely and easily remove the medicine 1360.

The terms “interior” and “interiorly” as they refer to the state or position of the cutting portion 62 includes arrangements in which the cutting surface is physically within the interior cavity of the upper jaw as well as those in which the cutting surface is alongside the upper jaw disposed above the lower margin 28. Both such arrangements prevent the cutting portion from being generally exposed.

While only one blade has been illustrated, embodiments can include multiple blades to provide further cutting of any package received in devices otherwise constructed as described above.

While the invention has been illustrated in detail with particular reference to certain embodiments thereof, and described in connection with the illustrated embodiments and variations thereof, the invention is capable of different embodiments and insubstantial variations, and its details are capable of modifications in various obvious respects. As will be readily apparent to those skilled in the art, variations and modifications can be affected while remaining within the spirit and scope of the invention. Accordingly, the accompanying drawing figures and the foregoing written description of certain embodiments and their variations and are for illustrative purposes only, and do not in any way limit the invention, which is defined only by the claims.

1. A method for opening a blister or clam shell package, comprising the steps of:
positioning the package between at least two moveable jaws, at least one of the moveable jaws including a blade having a cutting surface mounted so as to be moveable at least into proximity with the other of the moveable jaws;
after the positioning step, moving the jaws to a compressed position in which the cutting surface penetrates the package positioned therebetween;
sliding the jaws relative to the package while maintaining the jaws in said compressed position,
whereby a continuous linear cut through the package results.

2. The method of claim 1, wherein the moving step comprises urging the jaws to the compressed position against a restoring force of a bias.

3. The method of claim 1, wherein the moving step comprises permitting a restoring force to return the jaws to the compressed position.

4. The method of claim 1, including the additional step of disposing the cutting surface exterior of the said at least one moveable jaw.

5. A handheld device for cutting a package, comprising:
a first jaw and a second jaw;
a coupling connecting the first and second jaws and permitting relative movement of the first and second jaws to one another in response to a manual force;
a blade mounted to the first jaw and having a cutting surface disposed exteriorly of the first jaw, the blade being oriented to produce a linear cut through the package when the package is moved in a first direction; and
a bias operatively connected to the first and second jaws to counter the manual force so that the first and second jaws can move between i) a receiving position in which the first and second jaws are spaced at a distance sufficient to receive the package in a channel defined therebetween and ii) a cutting position in which the distance between the first and second jaws is decreased and in which the cutting surface penetrates any package received in the channel;
wherein movement of the package in the first direction, while the first and second jaws remain in the cutting position, produces the linear cut through the package, and
wherein the manual force acts against a restoring force of the bias.

6. The device of claim 5, further comprising a bearing surface associated with the second jaw, wherein the blade is disposed directly above or contacts the bearing surface when in the cutting position.

7. The device of claim 6, wherein the bearing surface further comprises a means for reducing a friction.

8. The device of claim 5, wherein the coupling comprises a hinge for pivotal movement of the jaws.

9. The device of claim 5, wherein the bias is operatively connected to normally space the first and second jaws at the receiving position and to resiliently permit the first and second jaws to move in response to the manual force to the cutting position.

10. A handheld device for cutting a package, comprising:
a first jaw and a second jaw;
a coupling connecting the first and second jaws and permitting relative movement of the first and second jaws to one another in response to a manual force;
a bias operatively connected to the first and second jaws to counter the manual force so that the first and second jaws can move between a cutting position and another position;
a blade having a cutting surface, the blade being moveably mounted relative to the first jaw and having a retracted state in which the cutting surface is disposed interiorly of the first jaw and an extended state in which the cutting surface is disposed exteriorly of the first jaw; and
means for moving the cutting surface between the retracted and extended states.

11. The device of claim 10, further comprising a bearing surface associated with the second jaw, wherein the blade is disposed directly above or contacts the bearing surface when in the cutting position.

12. The device of claim 10, wherein the moving means comprises a lever coupled to the blade and permitting movement of the cutting surface between the retracted and extended states.

13. The device of claim 12, wherein state of cutting surface is controlled independent of position of jaws.

14. The device of claim 12, wherein the lever is manually movable to effect movement of the cutting surface to the extended state.

15. The device of claim 12, wherein the moving means further comprises a blade support, the blade being at least partially seated in the blade support.

16. The device of claim 12, further comprising a second bias to return the cutting surface to the retracted state.

17. The device of claim 10, wherein the moving means comprises a trigger disposed between the first and second jaws and responsive to any pressure applied thereupon as a result of movement of the first and second jaws to extend the cutting surface exteriorly of the first jaw.

18. The device of claim 10, wherein the said another position is a receiving position in which the first and second jaws are spaced at a distance sufficient to receive the package, and wherein the bias is operatively connected to normally space the first and second jaws at the receiving position and to resiliently permit the first and second jaws to move in response to the manual force to the cutting position.

19. The device of claim 10, further comprising a cam associated with one of the first and second jaws and wherein the manual force, when applied to the cam, moves the jaws to the said another position.

20. A handheld device for cutting a package, comprising:
a first jaw and a second jaw, the first and second jaws being spaced from one another at a fixed distance which is sufficient to receive the package in a channel defined at least partially therebetween;
a blade having a cutting surface, the blade being moveably mounted relative to the first jaw and having a retracted state in which the cutting surface is disposed interiorly of the first jaw and an extended state in which the cutting surface is disposed exteriorly of the first jaw yet within the channel so as to penetrate any package that has been received in the channel; and
a lever connected to the blade and operative to move the cutting surface between the retracted and extended states.

21. The device of claim 20, further comprising a bias operatively connected to the blade to resiliently resist movement of the lever so as to maintain the cutting surface in the retracted state in the absence of a manual force that is sufficient to overcome the bias.
